(19) United States
(12) Patent Application Publication
(10) Pub. No.: US 2009/0150246 A1
(43) Pub. Date: Jun. 11, 2009

(54) AUTOMATIC FILTERING OF POS DATA

(75) Inventors: Sundaresan K. Meenakshi, Madurai (IN); Sivakumar Balakrishnan, Madurai (IN); Gopalakrishnan V. Venkatesan, Madurai (IN); Abdul M. Raheem, Madurai (IN); Ganesh G. Babu, Coimbatore (IN)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/951,690

(22) Filed: Dec. 6, 2007

(51) Int. Cl. G06Q 20/00

(52) U.S. Cl. 705/16; 235/375; 705/24

(57) ABSTRACT

An inventive system and method for processing transactional data in a point of sale environment is provided. The system includes a video device that can record video output, a POS terminal that generates unfiltered transactional data, a filtering unit that filters the unfiltered transactional data to create filtered transactional data, and a recording device that can combine said video output and said filtered transactional data, such that the filtering unit filters the unfiltered transactional data using automatic rules identification. A POS printer that prints the unfiltered transactional data can also be included, such that the filtering unit transmits unfiltered transactional data to the POS printer.

### FIELD OF THE INVENTION

This invention relates generally to security for point of sale systems. In particular, this invention relates to processing transactional data to enhance the security of a point of sale system.

### BACKGROUND OF THE INVENTION

Many commercial establishments employ video systems that record activities at various locations within the premises of the establishment for the purpose of surveillance. One of the important locations to watch is the place where money transactions occur, that is, the Point-Of-Sale (POS) locations. Although a video recording at POS is essential piece of security equipment, it is not sufficient, because a video system can capture only what is happening at the location but cannot decipher why it is happening. To understand the complete situation, it is also necessary to record all the buying and selling details occurring at the location, such as the details or data entered in billing-machines or cash registers.

Typically, an establishment's employee, or cashier, enters identification and quantity of a product to be purchased into the cash register that then sends the “sale” transaction, e.g., Product Name, Quantity and Price, to a printer for printing the bill or sales receipt. By capturing this sale transaction and comparing it with the video recording, it is possible to get comprehensive details of what is happening at the POS location. The transactions that happen at the POS location are sent from the cash register to a transaction-capturing device that captures these transactions. This device can be placed between the cash register and a printer if one is present at the location. The device then formats the captured data and sends it to the video system that records the video along with the transactions, so that any transaction that needs to be verified for its validity can be checked with the corresponding video.

The need for this verification often happens, for example, with transactions termed ‘Void’ transactions. A void transaction is one that has been cancelled by the cashier for a variety of reasons, such as the product is damaged or defective. In a void transaction, no money is taken from a purchaser, but the product's tag is disabled. It is therefore possible for the employee or cashier at the POS to record a void transaction and give away the product to the customer, who can take it without raising any alarms. However, if a video with the transactions were saved, it would be possible to detect such frauds on comparing both.

For saving or storage purposes, the video system requires only the specific transaction information and does not require redundant data like printer commands, bill header information, etc. Such redundant data, as well as other junk characters, make finding the transactions that need to be verified difficult and cumbersome, since a large amount of data would have to be examined. The redundant information will also increase the storage space. Accordingly, the transaction-capturing device will be programmed to eliminate this data before transmitting transaction information to the video system. However, since each cash register may generate a different format for its output, the same firmware cannot be used at all locations. The firmware will need to be programmed to accommodate the cash register and location specific details.

Among the problems of the aforementioned systems is the necessity for the firmware to directly interface with the cash register, so that distinct firmware is needed for each type of cash register. Hence, a new cash register will require the development of new firmware, because if the programmed firmware does not match the cash register for which it was designed, the transaction data will be difficult to decipher. Further, if the commercial establishment changes the cash register it uses, the transaction capturing device has to be re-programmed with the firmware that supports the new cash-register. Thus, the problem of maintaining a large database of firmware and deploying the right one for a cash register occurs.

U.S. Pat. No. 6,847,393, Ashe et al., for Method and System for Monitoring Point of Sale Exceptions, discloses analyzing event transactional data for certain patterns or occurrences. The system defines events that enable the identification of abnormal repetitions or patterns of certain activities that are indicative of fraud, theft or inadequate training that warrant investigation. Instead of a separate transaction-capturing device, a software machine collects both transactional data and video signals, and processes the information to raise exceptions. Ashe et al. do not remove redundant data; instead they process all data in hopes of identifying pre-defined events and detecting fraudulent information.

### SUMMARY OF THE INVENTION

The present invention advantageously provides a system and method in which the output from a cash register can be combined with video recordings and used by any device for various purposes, including fraud detection, transaction recording for auditing, transaction recording for analysis on sales, etc. This invention deals with processing of the transactional data so as to eliminate the redundant information from the data and hence reduce the data saved in a database or other device having video and its matching transactional data. The transactional data from the cash register is formatted and sent to another device that can also perform further processing for fraud analysis.

The inventive system and method for processing transactional data in a point of sale environment includes a video device that can record video output, a POS terminal that generates unfiltered transactional data, a filtering unit that filters the unfiltered transactional data to create filtered transactional data, and a recording device that can combine said video output and said filtered transactional data, such that the filtering unit filters the unfiltered transactional data using automatic rules identification. A POS printer that prints the unfiltered transactional data can also be included, such that the filtering unit transmits unfiltered transactional data to the POS printer.

The foregoing and other objects, aspects, features, advantages of the invention will become more apparent from the following description and from the claims.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a block diagram of an exemplary embodiment of the present invention;

FIG. 2 is a flow diagram of the adaptation mode of the present invention;

FIG. 3 is a flow diagram of the adaptation mode;

FIG. 4 is a flow diagram of the filtering technique;

FIG. 5 is an example of transactional data; and

FIG. 6 is an example of creation of a filter.

### DETAILED DESCRIPTION OF THE INVENTION

An inventive solution is presented to the need for enhancing the security of a point of sale environment by using transactional data in addition to video information recorded in the environment. The novel solution includes processing transaction data to eliminate redundancies.

FIG. 1 shows an exemplary embodiment of the invention. The point of sale environment 10 has a camera or video recording device 12, a POS terminal 14, and a POS printer 16. The camera 12 transmits its recorded video output to a recording device 18. The terminal 14 transmits its transactional or incoming data to a filtering unit 20 that transmits the transactional data to the printer 16. In addition, the filtering unit 20 has firmware 22 that filters the transactional or incoming data using an automatic processing technique implemented characteristics 24 in an automatic rule identification 26, discussed below. The filtered data is transmitted to the recording device 18 and combined with the video output from the camera 12, providing both visual and transactional details about each POS transaction. Transmission within the point of sale environment 10 can be performed using RS232/422/485, or TCP/IP or USB.

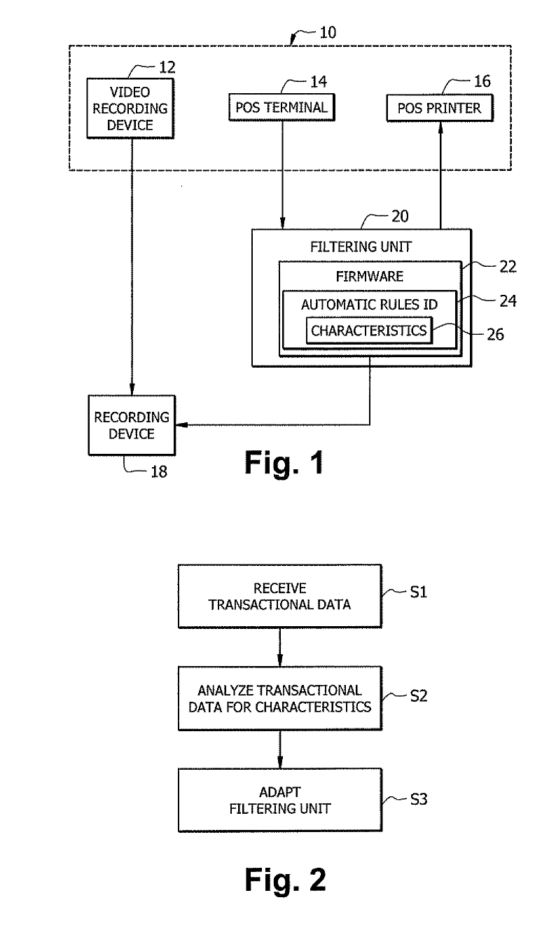

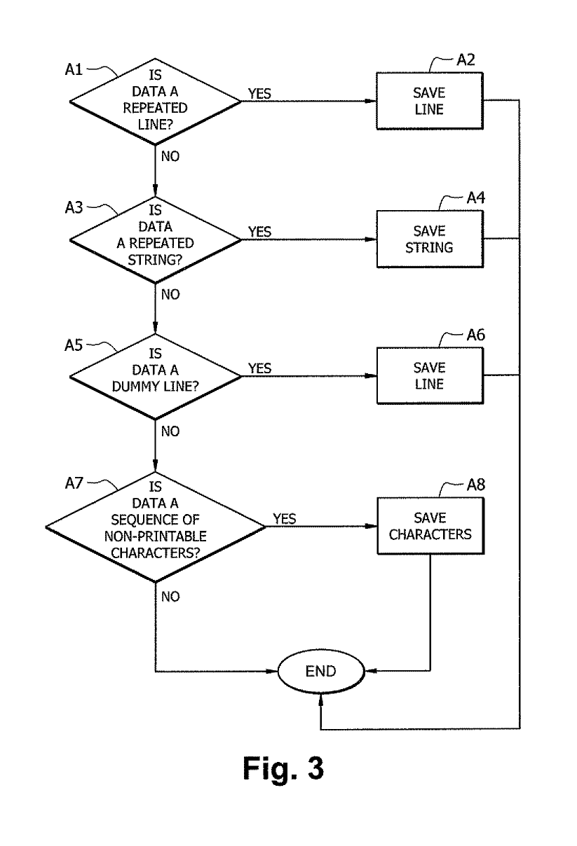

FIG. 2 shows the steps the automatic processing technique performs in an adaptation mode to adapt to the data from the terminals or cash registers 14 and to create automatic rules identification 26. In step S1, the filtering unit 20 receives the transactional data from the terminal 14. This data is analyzed for characteristics 24 by the filtering unit 20 in step S2, and recurring or redundant data are identified. Details of step S2 are shown in FIG. 3 and discussed below. The filtering unit or device 20 adapts itself to the incoming data by storing this redundant information or characteristic 24 in step S3, creating the automatic rules identification 26.

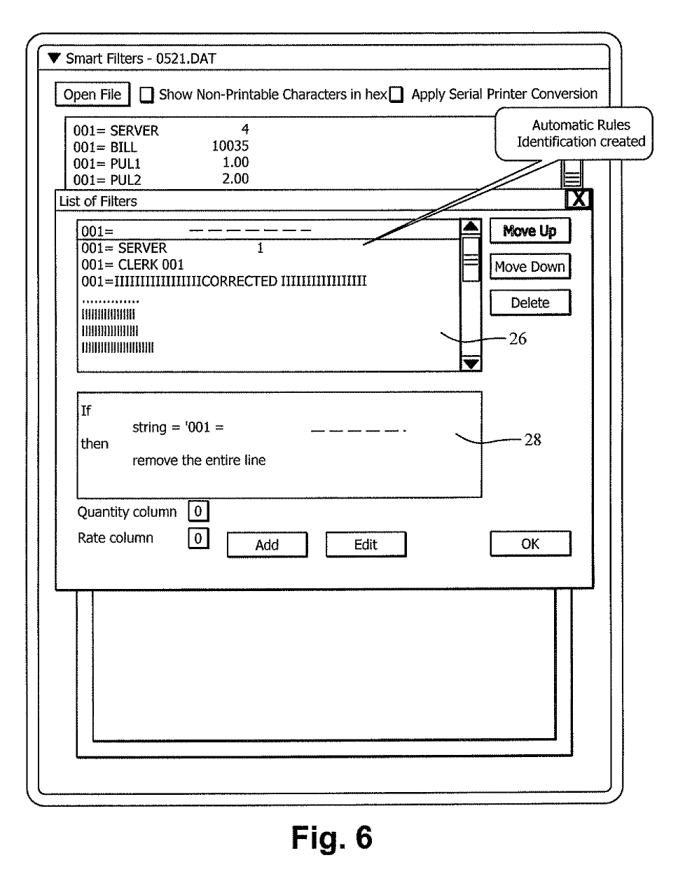

The filtering unit 20 begins with a set of rules based on which the unit 20 determines whether or not a data can be eliminated. This set of rules forms the basis of the data analysis or adaptation process shown in step S2 and in detail in FIG. 3. Each rule can be a characteristic 24 of the transactional data. A user or technician can add rules and/or modify the existing rules. These rules are adapted to become automatic rules identification 26, which can also be modified or enhanced by a user or technician. An example of a characteristic 24 and automatic rules identification 26 is shown in FIG. 6.

In one embodiment, illustrated in FIG. 3, the set of rules for the filter unit's 20 adaptation process mode includes the following steps. In step A1, check for repeated lines. When a certain line occurs periodically, it may be header or other generic information that does not need to be recorded by the recording device 18. If such a line occurs, it is saved during adaptation mode in automatic rules identification. 26 in step A2, so that the line will be eliminated from transactional data. Periodically can mean, for example, that the line repeats about once every 10-15 lines.

In step A3, check for repeated strings. When a certain string occurs frequently, it may be non-transaction information that can be safely removed. If such strings occur, in step A4 they are saved during adaptation mode as characteristics 24 in automatic rules identification 26 so that the data will be eliminated from the transactional data sent to the recording device 18. In step A5, check for dummy lines. When a line does not contain any numbers, the line must be a formatting line or header information, as opposed to transactional data. For example, lines such as ‘______’ often occur in the data for marking the total. Such lines are saved during adaptation mode as characteristics 24 in automatic rules identification 26 in step A6, so that these lines can be eliminated from the transactional data sent to the recording device 18. In step A7, check for non-printable characters. When a sequence of non-printable characters occurs, the characters must be printer commands. Such character sequences are saved during adaptation mode as characteristics 24 in automatic rules identification 26 in step A8, so that these sequences can be eliminated from the transactional data sent to the recording device 18.

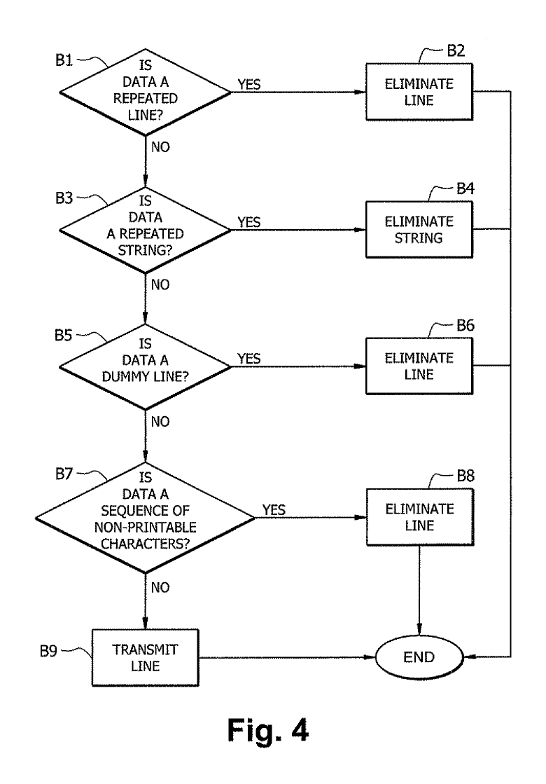

FIG. 4 shows a flow when the filter unit 20 is operating in standard, not adaptation, mode. In step B 1, the transactional or incoming data is checked against the automatic rules identification 26 for the characteristic 24 of repeated lines. If there is a match, the incoming data is eliminated from transactional data in step B2. In step B3, the incoming data is checked against the automatic rules identification 26 for the characteristic 24 of repeated strings. If there is a match, the incoming string is eliminated from transactional data in step B4 and the remaining data is transmitted to the recording device 18. In step B5, the incoming data is checked against the automatic rules identification 26 for the characteristic 24 of dummy lines. If there is a match, the incoming line is eliminated from transactional data in step B6. In step B7, the incoming data is checked against the automatic rules identification 26 for the characteristic 24 of a sequence of non-printable characters. If there is a match, the sequence is eliminated from transactional data in step B8. The remaining data, if a match is found, or all of the data, if no match is found, is transmitted in step B9 to the recording device 18.

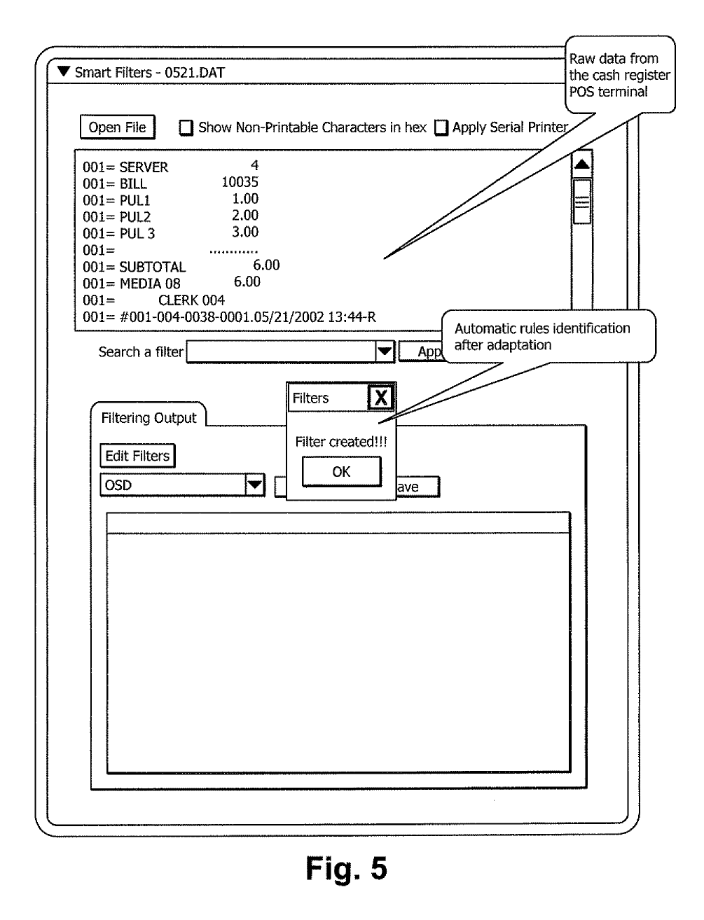

FIG. 5 shows sample transactional data from a POS terminal 14. FIG. 6 shows a sample automatic rules identification 26 created from the transactional data in FIG. 4. Specifically, based on a rule that a line having no numbers to the right of the equal (=) sign can be eliminated, the automatic rules identification 26 contains characteristic 24 “If string=‘001=______’ then remove the entire line”.

After executing in adaptation mode for a prescribed period, the device 20 starts transmitting valid, non-redundant output data to the recording device 18 for matching with the output from the video recording device 12. Hence, in the adaptation mode, the firmware 22 of the filtering unit 20 will automatically create rules having the appropriate characteristic 24, so that no additional engineering or programming effort is needed to support a new cash register or POS terminal 14. Errors caused by a mismatch between firmware 22 and POS terminal 14 can be eliminated since the firmware 22 is the same for all POS terminals 14. Accordingly, if a commercial establishment changes one or more of its POS terminals 14, the filtering unit 20 can be set to adaptation mode to create the appropriate rules identification 26 in the firmware 22. There is no longer a need for a database of firmware, since a single adaptable firmware 22 exists for all PO terminals 14.

The embodiments described above are illustrative examples and it should not be construed that the present invention is limited to these particular embodiments. Thus, various changes and modifications may be effected by one skilled in the art without departing from the spirit or scope of the invention as defined in the appended claims.

What is claimed is:

1. A system for processing transactional data in a point of sale environment, said system comprising:
a video device recording video output;
a POS terminal generating unfiltered transactional data;
a filtering unit filtering said unfiltered transactional data to create filtered transactional data; and
a recording device operable to combine said video output and said filtered transactional data, wherein said filtering unit filters said unfiltered transactional data using automatic rules identification.

2. The system according to claim 1, wherein the automatic rules identification is created using a set of rules.

3. The system according to claim 2, wherein the automatic rules identification is created using an adaptation process based on said set of rules.

4. The system according to claim 1, wherein said filtering removes redundant data.

5. The system according to claim 1, further comprising a POS printer operable to print said unfiltered transactional data, wherein said filtering unit transmits said unfiltered transactional data to said POS printer.

6. The system according to claim 1, wherein a user or technician modifies the automatic rules identification.

7. The system according to claim 1, wherein a user or technician adds new rules to the automatic rules identification.

8. A method for processing transactional data in a point of sale environment, comprising the steps of:
recording video output;
generating unfiltered transactional data;
filtering said unfiltered transactional data to create filtered transactional data; and
combining said video output and said filtered transactional data, wherein said filtering is done using automatic rules identification.

9. The method according to claim 8, wherein the automatic rules identification is created using a set of rules.

10. The method according to claim 9, wherein the automatic rules identification is created using an adaptation process based on said set of rules.

11. The method according to claim 8, wherein the automatic rules identification is created using an adaptation process comprising the steps of:
checking the unfiltered transactional data for a characteristic; and
if the unfiltered transactional data contains the characteristic, then storing the characteristic in the automatic rules identification.

12. The method according to claim 8, wherein the step of filtering further comprises the steps of:
checking the unfiltered transactional data for a characteristic; and
if the unfiltered transactional data does not contain the characteristic, then transmitting the unfiltered transactional data as filtered transactional data.

13. The method according to claim 8, wherein the step of filtering removes redundant data.

14. The method according to claim 8, further comprising the step of printing the unfiltered transactional data.

15. The method according to claim 8, wherein the step of filtering further comprises modifying the automatic rules identification.

16. The method according to claim 8, wherein the step of filtering further comprises adding new rules to the automatic rules identification.
